(19) United States
(12) Patent Application Publication
(10) Pub. No.: US 2017/0272933 A1
(43) Pub. Date: Sep. 21, 2017

(54) METHOD OF REALIZING VIRTUAL SUBSCRIBER IDENTITY MODULE CARD AND SYSTEM THEREOF

(71) Applicant: HuiZhou TCL Mobile Communication Co., Ltd., HuiZhou (CN)

(72) Inventors: Shiqing ZHAO, HuiZhou (CN); Shenggang HU, HuiZhou (CN); Aiping George GUO, HuiZhou (CN)

(73) Assignee: HuiZhou TCL Mobile Communication Co., Ltd., HuiZhou (CN)

(21) Appl. No.: 15/321,196

(22) PCT Filed: Apr. 7, 2016
(86) PCT No.: PCT/CN2016/078648

§ 371 Date: Dec. 22, 2016

(30) Foreign Application Priority Data
Sep. 14, 2015 (CN) 201510580958.7

(51) Int. Cl. H04W 8/18; H04L 29/06; H04W 12/06

(52) U.S. Cl. CPC H04W 8/18; H04W 12/06; H04L 63/0876

(57) ABSTRACT

A method of realizing a virtual subscriber identity module (SIM) card includes: storing the data stored in the virtual SIM card to a cloud server, and connecting the mobile terminal to the cloud server through a network, reading the data stored in the virtual SIM card stored in the corresponding cloud server, and establishing a mapping relation between the mobile terminal and the virtual SIM card through authentication. In the present disclosure, the mobile terminal is bonded with a SIM card, the SIM card is multifunctional, and a single SIM card corresponds to a plurality of terminals.

### BACKGROUND

1. Field of the Disclosure

The present disclosure relates to the field of wireless communication, and more particularly, to a method of realizing a virtual subscriber identity module (SIM) card and a system thereof.

2. Description of the Related Art

With the upcoming approach of the fifth generation of the mobile communication technology the fifth generation (5G), Internet of Things (IoT), Internet of cars, intelligent households, intelligent terminals, intelligent wearable devices, and so on become more popular and intense so a person has more and more intelligent devices. Features of discreteness, territoriality, multi-category, synchronously real-time online, and virtuality are more outstanding. Therefore, there's no doubt that there is a growing tendency to develop a multi-machine card, a multi-purpose card, and a multi-location card.

A traditional subscriber identity module (SIM) card is a physical card and is usually put in a terminal. The data stored in the SIM card is read and authenticated by the terminal and normal communication starts after authentication. A physical SIM card is inserted and bonded in a terminal at a certain time point. Once a user's SIM card is lost, he/she cannot communicate with other people. Because the user has to depend on the SIM card completely, it is really a big trouble if he/she loses the SIM card.

Therefore, it is necessary to improve and develop the conventional technology.

### SUMMARY

In light of the shortcomings of the conventional technology, an object of the present disclosure is to propose a method of realizing a virtual subscriber identity module (SIM) card and a system to solve a problem related to a mobile terminal where a conventional SIM card is installed. Conventionally, it is not very convenient for the user to use a plurality of mobile terminals since each of the plurality of mobile terminals needs to be equipped with a SIM card. Also, in case the cell of some cellphones is hard to be taken apart, the SIM cards need to be replaced so that other mobile terminals can connect to the Internet.

According to the present disclosure, a method of realizing a virtual subscriber identity module (SIM) card includes:

storing the data stored in the virtual SIM card to a cloud server, the data stored in the virtual SIM card comprising a number, the authentication data, and a key of the virtual SIM card;

setting a unique address where the virtual SIM card is stored in advance, and relating the unique address to the number of the virtual SIM card; and

connecting the mobile terminal to the cloud server through a network, reading the data stored in the virtual SIM card stored in the corresponding cloud server, and establishing a mapping relation between the mobile terminal and the virtual SIM card through authentication.

Furthermore, a step of connecting the mobile terminal to the cloud server through the network, reading the data stored in the virtual SIM card stored in the corresponding cloud server, and establishing the mapping relation between the mobile terminal and the virtual SIM card through the authentication comprises steps of:

connecting the mobile terminal to the cloud server through a network such as wireless-fidelity (Wi-Fi), an operator network, or a broadband network;

reading the data stored in the virtual SIM card corresponding to the cloud server and sending the authentication data with the mobile terminal; and

establishing the mapping relation between the mobile terminal and the virtual SIM card after the authentication of the virtual SIM card.

Furthermore, upon a condition that the network is the Wi-Fi network, the mobile terminal connected to the cloud server through the Wi-Fi network comprises steps of:

connecting the mobile terminal to a Wi-Fi router through the Wi-Fi network; and

connecting the Wi-Fi router to the cloud server through the broadband.

Furthermore, the operator network is selected from a fourth generation of mobile phone mobile communication technology standards (4G) network, a third generation of mobile phone mobile communication technology standards (3G) network, and a second generation of mobile phone mobile communication technology standards (2G) network.

According to the present disclosure, a method of realizing a virtual subscriber identity module (SIM) card, includes:

storing the data stored in the virtual SIM card to a cloud server; and

connecting the mobile terminal to the cloud server through a network, reading the data stored in the virtual SIM card stored in the corresponding cloud server, and establishing a mapping relation between the mobile terminal and the virtual SIM card through authentication.

Furthermore, a step of storing the data stored in the virtual SIM card to a cloud server in advance, comprises:

storing a number, authentication data, and a key of the virtual SIM card in the cloud server; and

setting a unique address where the virtual SIM card is stored.

Furthermore, a step of connecting the mobile terminal to the cloud server through the network, reading the data stored in the virtual SIM card stored in the corresponding cloud server, and establishing the mapping relation between the mobile terminal and the virtual SIM card through the authentication comprises steps of:

connecting the mobile terminal to the cloud server through a network such as wireless-fidelity (Wi-Fi), an operator network, or a broadband network;

reading the data stored in the virtual SIM card corresponding to the cloud server and sending the authentication data with the mobile terminal; and

establishing the mapping relation between the mobile terminal and the virtual SIM card after the authentication of the virtual SIM card.

Furthermore, upon a condition that the network is the Wi-Fi network, the mobile terminal connected to the cloud server through the Wi-Fi network comprises steps of:

connecting the mobile terminal to a Wi-Fi router through the Wi-Fi network; and

connecting the Wi-Fi router to the cloud server through the broadband.

Furthermore, the operator network is selected from a fourth generation of mobile phone mobile communication technology standards (4G) network, a third generation of mobile phone mobile communication technology standards (3G) network, and a second generation of mobile phone mobile communication technology standards (2G) network.

According to the present disclosure, a system of realizing a virtual subscriber identity module (SIM) card, includes:

a pre-storage module, configured to store the data stored in the SIM card to the cloud server;

a connection and authentication module, configured to establish a mapping relation of the virtual SIM card through authentication when the mobile terminal is connected to the cloud server through the network and reads the data of a corresponding virtual SIM card stored in the cloud server.

Furthermore, the pre-storage module comprises:

a pre-storage unit, configured to store the number, the authentication data, and the key of the virtual SIM card to the cloud server; and

a pre-set unit, configured to set a unique address where the virtual SIM card is stored.

Furthermore, the connection and authentication module comprises:

a network connection unit, configured to connect the mobile terminal to the cloud server through one of networks selected from wireless-fidelity (Wi-Fi) network, an operator network, or broadband network;

a data transmittance unit, configured to read the data stored in the virtual SIM card corresponding to the cloud server and send the authentication data with the mobile terminal; and

a mapping relation establishment unit, configured to establish the mapping relation between the mobile terminal and the virtual SIM card after the authentication of the virtual SIM card.

Furthermore, upon a condition that the network is the Wi-Fi network, the network connection unit comprises:

a first connection unit, configured to connect the mobile terminal to a Wi-Fi router through the Wi-Fi network; and

a second connection unit, configured to connect the Wi-Fi router to the cloud server through the broadband network.

Furthermore, the operator network is selected from a fourth generation of mobile phone mobile communication technology standards (4G) network, a third generation of mobile phone mobile communication technology standards (3G) network, and a second generation of mobile phone mobile communication technology standards (2G) network.

The present disclosure proposes a method of realizing a virtual subscriber identity module (SIM) card and a system. The method comprises steps of storing the data stored in a virtual SIM card to a cloud server in advance, connecting the mobile terminal to the cloud server through a network, reading the corresponding data stored in the virtual SIM card stored in the cloud server, and establishing a mapping relation between the mobile terminal and the virtual SIM card through authentication. In the present disclosure, the mobile terminal is bonded with a SIM card, the SIM card is multifunctional, and a single SIM card corresponds to a plurality of terminals. In this way, the SIM card can be flexibly used and more convenient in communications, which save costs. Besides, a new SIM card is required though the number of the SIM card is updated or replaced.

### BRIEF DESCRIPTION OF THE DRAWINGS

FIG. 1 shows a flow chart of a method of realizing a virtual subscriber identity module (SIM) card according to one preferred embodiment of the present disclosure.

FIG. 2 is a schematic diagram of the virtual SIM card stored in the cloud server.

FIG. 3 is a schematic diagram of a method of realizing a virtual SIM card according to the embodiment of the present disclosure.

FIG. 4 is a schematic diagram illustrating a mobile terminal connected to the virtual SIM card stored in a cloud server through a Wi-Fi network and a mobile terminal connected to a Wi-Fi router through the Wi-Fi network.

FIG. 5 is a functional block diagram illustrating the system of realizing the SIM card according to the embodiment of the present disclosure.

### DETAILED DESCRIPTION OF THE PREFERRED EMBODIMENTS

For the purpose of description rather than limitation, the following provides such specific details as a specific system structure, interface, and technology for a thorough understanding of the application. However, it is understandable by persons skilled in the art that the application can also be implemented in other embodiments not providing such specific details. In other cases, details of a well-known apparatus, circuit and method are omitted to avoid hindering the description of the application by unnecessary details.

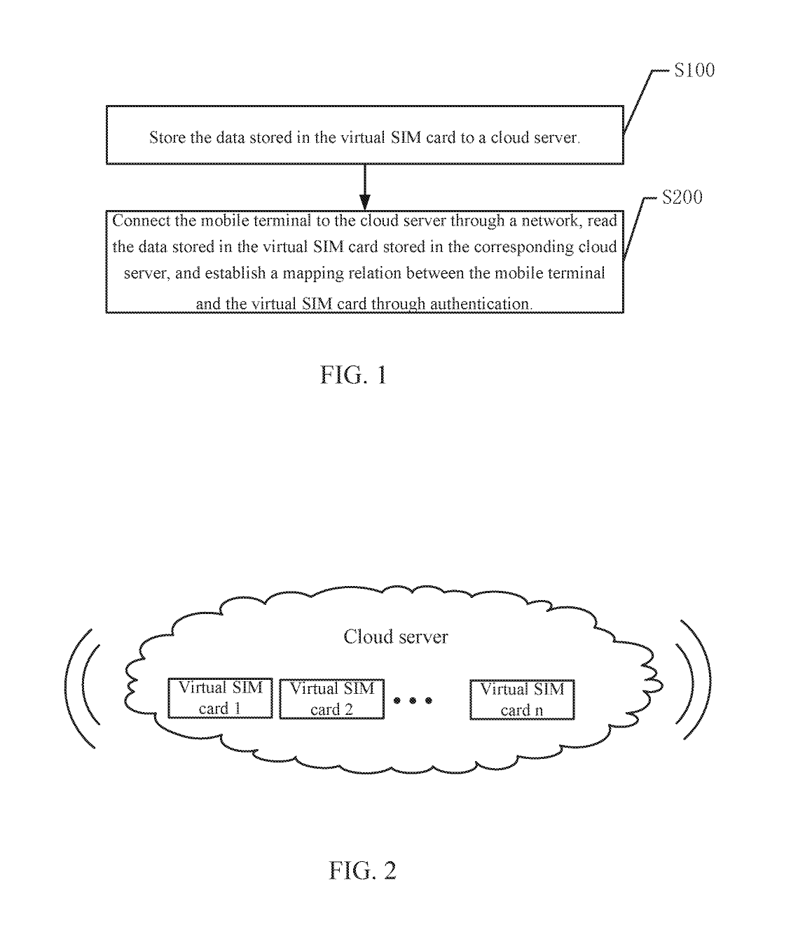

FIG. 1 shows a flow chart of a method of realizing a virtual subscriber identity module (SIM) card according to one preferred embodiment of the present disclosure. The method comprises steps as follows.

Step S100: Store the data stored in a virtual subscriber identity module (SIM) card to a cloud server in advance.

Step S100 comprises steps as follows.

Step S101: Store the number, the authentication data, and the key of the virtual SIM card to the cloud server in advance.

Step S102: Set a unique address where the virtual SIM card is stored in advance.

In real application, the data, such as the number, the authentication data, and the key of the virtual SIM card, is stored in the cloud server in advance. FIG. 2 is a schematic diagram of the virtual SIM card stored in the cloud server. Each of the SIM cards occupies some designated storage space in the cloud server. Each of the SIM cards is given an address in the cloud server for the user to find, search, and read. It is possible to relate the address to the number of the virtual SIM card so that the user can search for the virtual SIM card easily.

Step S200: Connect the mobile terminal to the cloud server through a network, read the data stored in the virtual SIM card stored in the corresponding cloud server, and establish a mapping relation between the mobile terminal and the virtual SIM card through authentication.

Step S200 further comprises steps as follows.

Step S201: Connect the mobile terminal to the cloud server through the network such as wireless-fidelity (Wi-Fi), an operator network, or a broadband network.

Step S202: Read the data stored in the virtual SIM card corresponding to the cloud server and send the authentication data with the mobile terminal.

Step S203: Establish the mapping relation between the mobile terminal and the virtual SIM card after gaining the authentication of the virtual SIM card.

The terminal can read a user's virtual SIM card through any type of network. After the key security authentication permits, the virtual SIM card stored in the cloud is mapped to a terminal designated by the user. In this way, the terminal is bonded to the virtual SIM card, and communication works through the virtual SIM card.

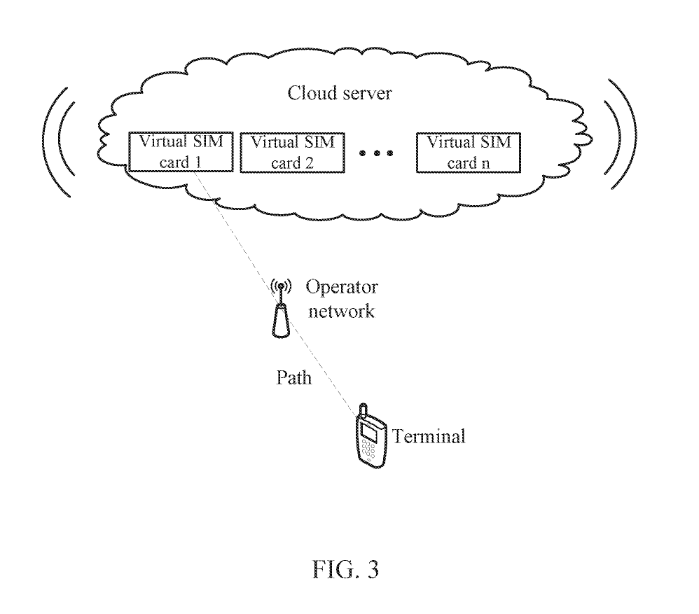

FIG. 3 is a schematic diagram of a method of realizing a virtual SIM card according to the embodiment of the present disclosure. In this embodiment, a mobile terminal is connected to the virtual SIM card stored in a cloud server through an operator network. The mobile terminal reads the SIM card stored in the authentication cloud server through any potential networks such as Wi-Fi, an operator, and broadband. It comprises, but is not limited to, the operator network in the SIM authentication mode. Ordinarily, a physical SIM card is authenticated through the operator network. Because of the SIM card stored in the cloud, more and more authentication paths are created. The virtual SIM card can be authenticated through the operator network or through the network such as Wi-Fi and broadband. In other words, the number of authentication path increases. The operator network comprises, but is not limited to, the fourth generation of mobile phone mobile communication technology standards (4G) network, the third generation of mobile phone mobile communication technology standards (3G) network, the second generation of mobile phone mobile communication technology standards (2G) network, or a potential new operator network such as the fifth generation of mobile phone mobile communication technology standards (5G) network.

When the mobile terminal is connected to the cloud server through the Wi-Fi network, Step S201 comprises steps as follows.

Step S211: Connect the mobile terminal to a Wi-Fi router through Wi-Fi.

Step S212: Connect the Wi-Fi router to the cloud server through broadband.

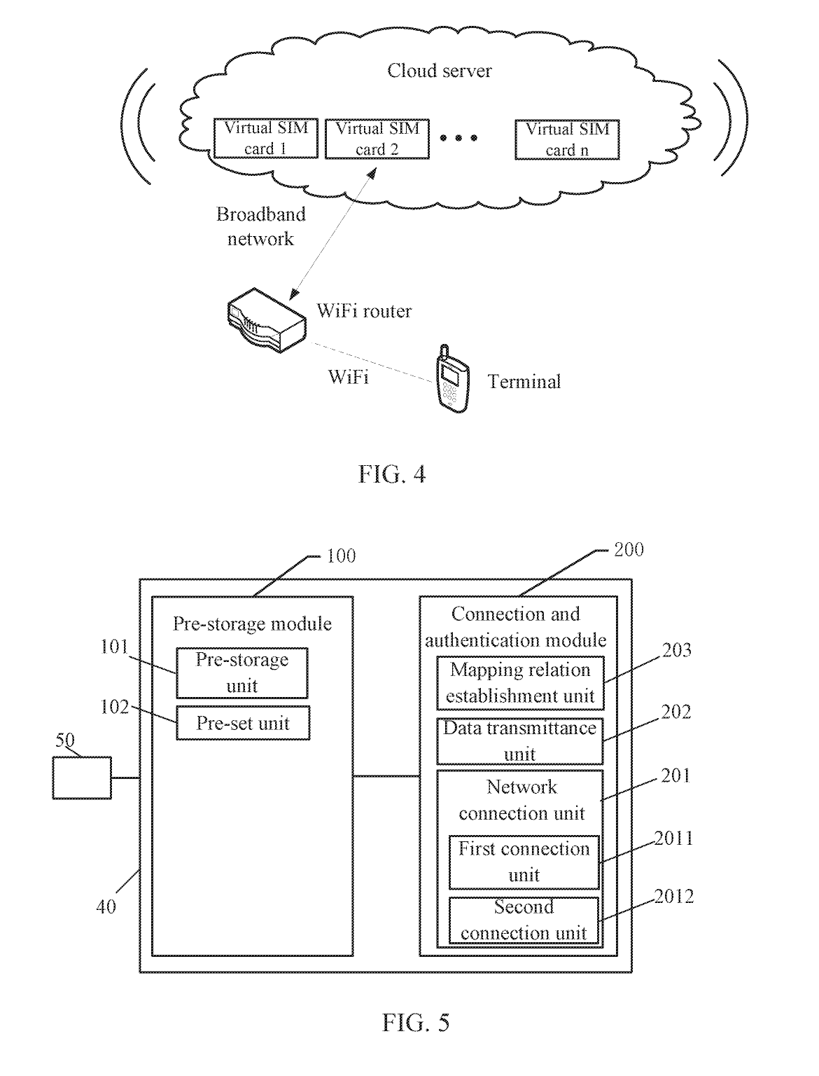

FIG. 4 is related to a preferred embodiment where a virtual subscriber identity module (SIM) card is realized. FIG. 4 is a schematic diagram illustrating a mobile terminal connected to the virtual SIM card stored in a cloud server through a Wi-Fi network and a mobile terminal connected to a Wi-Fi router through the Wi-Fi network. The Wi-Fi router reads the virtual SIM card stored in an authentication cloud through broadband.

The present disclosure proposes a method of realizing the virtual SIM card. The method is of storing the data about the SIM card stored in the cloud server, reading the SIM card stored in the authentication cloud server with the mobile terminal through any potential network read authentication modes such as wireless-fidelity (Wi-Fi), an operator network, or a broadband network, and mapping the virtual SIM card to the target terminal. The present disclosure makes it possible that the user's mobile terminal can be connected to the virtual SIM card stored in the cloud server where data is stored through a plurality of networks to achieve successful communication. Therefore, a multi-machine card, a multi-purpose card, and a multi-location card are implemented. Once the user uses another mobile terminal to call, text, or use traffic packages, he/she does not need to change his/her SIM card. It is a big help for the user.

Further, FIG. 5 is a functional block diagram illustrating the system of realizing the SIM card according to the embodiment of the present disclosure. The system comprises a pre-storage module 100 and a connection and authentication module 200.

The pre-storage module 100 is used to store the data stored in the SIM card to the cloud server.

The connection and authentication module 200 is used to establish a mapping relation of the virtual SIM card through authentication when the mobile terminal is connected to the cloud server through the network and reads the data of a corresponding virtual SIM card stored in the cloud server

In the realization system of the virtual SIM card, the pre-storage module 100 comprises a pre-storage unit and a pre-set unit.

The pre-storage unit is used to store the number, the authentication data, and the key of the virtual SIM card to the cloud server in advance.

The pre-set unit is used to set a unique address where the virtual SIM card is stored in advance.

In the realization system of the virtual SIM card, the connection and authentication module 200 comprises a network connection unit, a data transmittance unit, and a mapping relation establishment unit.

The network connection unit is used to connect the mobile terminal to the cloud server through one kind of network, such as wireless-fidelity (Wi-Fi), an operator network, or a broadband network.

The data transmittance unit is used to read the data stored in the virtual SIM card corresponding to the cloud server and send the authentication data with the mobile terminal.

The mapping relation establishment unit is used to establish the mapping relation between the mobile terminal and the virtual SIM card after the authentication of the virtual SIM card.

In the realization system of the virtual SIM card, upon a condition that the network is the Wi-Fi network, the network connection unit further comprises a first connection unit and a second connection unit.

The first connection unit is used to connect the mobile terminal to the Wi-Fi router through Wi-Fi.

The second connection unit is used to connect the Wi-Fi router to the cloud server through broadband network.

The operator network is the 4G network, the 3G network, the 2G network, or a new network of a potential operator.

In sum, the present disclosure proposes a method of realizing a virtual subscriber identity module (SIM) card and a system. The method comprises steps of storing the data stored in a virtual SIM card to a cloud server in advance, connecting the mobile terminal to the cloud server through a network, reading the corresponding data stored in the virtual SIM card stored in the cloud server, and establishing a mapping relation between the mobile terminal and the virtual SIM card through authentication. In the present disclosure, the mobile terminal is bonded with a SIM card, the SIM card is multifunctional, and a single SIM card corresponds to a plurality of terminals. In this way, the SIM card can be flexibly used and more convenient in communications, which save costs. Besides, a new SIM card is required though the number of the SIM card is updated or replaced.

As for the method of realizing a virtual subscriber identity module card according to the embodiments of the present disclosure, those of ordinary skill in the art would understand that all or part of the processes of the method of realizing a virtual subscriber identity module card according to the embodiments of the present disclosure can be completed through using computer program instructions to control relevant hardware. The computer program instructions may be stored in a computer readable storage medium, such as being stored in a memory of the smart terminal and being executed by at least one processor in the smart terminal. The executing process may include the flows provided by the embodiments showing the various methods. The storage medium may be a magnetic disk, an optical disk, a read-only memory (ROM), or a random access memory (RAM), etc.

As for the system of realizing a virtual subscriber identity module card according to the embodiment of the present disclosure, the various functional modules may be integrated into a processing chip, or the various modules may physically exist individually, or two or more than two modules may be integrated into a module. The integrated module may be implemented by using hardware, or may be implemented by using a software functional module. If the integrated module is implemented by using the software functional module and serves as a standalone product to be sold or used, it may be stored in a computer readable storage medium. The storage medium is, for example, a read-only memory, a magnetic disk, or an optical disk, etc.

The present disclosure is described in detail in accordance with the above contents with the specific preferred examples. However, this present disclosure is not limited to the specific examples. For the ordinary technical personnel of the technical field of the present disclosure, on the premise of keeping the conception of the present disclosure, the technical personnel can also make simple deductions or replacements, and all of which should be considered to belong to the protection scope of the present disclosure.

1. A method of realizing a virtual subscriber identity module (SIM) card, comprising:
storing the data stored in the virtual SIM card to a cloud server, the data stored in the virtual SIM card comprising a number, the authentication data, and a key of the virtual SIM card;
setting a unique address where the virtual SIM card is stored in advance, and relating the unique address to the number of the virtual SIM card; and
connecting the mobile terminal to the cloud server through a network, reading the data stored in the virtual SIM card stored in the corresponding cloud server, and establishing a mapping relation between the mobile terminal and the virtual SIM card through authentication.

2. The method of claim 1, wherein a step of connecting the mobile terminal to the cloud server through the network, reading the data stored in the virtual SIM card stored in the corresponding cloud server, and establishing the mapping relation between the mobile terminal and the virtual SIM card through the authentication comprises steps of:
connecting the mobile terminal to the cloud server through a network such as wireless-fidelity (Wi-Fi), an operator network, or a broadband network;
reading the data stored in the virtual SIM card corresponding to the cloud server and sending the authentication data with the mobile terminal; and
establishing the mapping relation between the mobile terminal and the virtual SIM card after the authentication of the virtual SIM card.

3. The method of claim 2, wherein upon a condition that the network is the Wi-Fi network, the mobile terminal connected to the cloud server through the Wi-Fi network comprises steps of:
connecting the mobile terminal to a Wi-Fi router through the Wi-Fi network; and
connecting the Wi-Fi router to the cloud server through the broadband.

4. The method of claim 2, wherein the operator network is selected from a fourth generation of mobile phone mobile communication technology standards (4G) network, a third generation of mobile phone mobile communication technology standards (3G) network, and a second generation of mobile phone mobile communication technology standards (2G) network.

5. A method of realizing a virtual subscriber identity module (SIM) card, comprising:
storing the data stored in the virtual SIM card to a cloud server; and
connecting the mobile terminal to the cloud server through a network, reading the data stored in the virtual SIM card stored in the corresponding cloud server, and establishing a mapping relation between the mobile terminal and the virtual SIM card through authentication.

6. The method of claim 5, wherein a step of storing the data stored in the virtual SIM card to a cloud server in advance, comprises:
storing a number, authentication data, and a key of the virtual SIM card in the cloud server; and
setting a unique address where the virtual SIM card is stored.

7. The method of claim 6, wherein a step of connecting the mobile terminal to the cloud server through the network, reading the data stored in the virtual SIM card stored in the corresponding cloud server, and establishing the mapping relation between the mobile terminal and the virtual SIM card through the authentication comprises steps of:
connecting the mobile terminal to the cloud server through a network such as wireless-fidelity (Wi-Fi), an operator network, or a broadband network;
reading the data stored in the virtual SIM card corresponding to the cloud server and sending the authentication data with the mobile terminal; and
establishing the mapping relation between the mobile terminal and the virtual SIM card after the authentication of the virtual SIM card.

8. The method of claim 7, wherein upon a condition that the network is the Wi-Fi network, the mobile terminal connected to the cloud server through the Wi-Fi network comprises steps of:
connecting the mobile terminal to a Wi-Fi router through the Wi-Fi network; and
connecting the Wi-Fi router to the cloud server through the broadband.

9. The method of claim 7, wherein the operator network is selected from a fourth generation of mobile phone mobile communication technology standards (4G) network, a third generation of mobile phone mobile communication technology standards (3G) network, and a second generation of mobile phone mobile communication technology standards (2G) network.

10. A system of realizing a virtual subscriber identity module (SIM) card, comprising:
a processor;
a memory connected with processor, the memory comprising a plurality of program instructions executable by the processor, the plurality of program instructions comprising:
a pre-storage module, configured to cause the processor to store the data stored in the SIM card to the cloud server;
a connection and authentication module, configured to cause the processor to establish a mapping relation of the virtual SIM card through authentication when the mobile terminal is connected to the cloud server through the network and reads the data of a corresponding virtual SIM card stored in the cloud server.

11. The system of claim 10, wherein the pre-storage module comprises:
a pre-storage unit, configured to cause the processor to store the number, the authentication data, and the key of the virtual SIM card to the cloud server; and
a pre-set unit, configured to cause the processor to set a unique address where the virtual SIM card is stored.

12. The system of claim 11, wherein the connection and authentication module comprises:
a network connection unit, configured to cause the processor to connect the mobile terminal to the cloud server through one of networks selected from wireless-fidelity (Wi-Fi) network, an operator network, or broadband network;
a data transmittance unit, configured to cause the processor to read the data stored in the virtual SIM card corresponding to the cloud server and send the authentication data with the mobile terminal; and
a mapping relation establishment unit, configured to cause the processor to establish the mapping relation between the mobile terminal and the virtual SIM card after the authentication of the virtual SIM card.

13. The system of claim 11, wherein upon a condition that the network is the Wi-Fi network, the network connection unit comprises:
a first connection unit, configured to cause the processor to connect the mobile terminal to a Wi-Fi router through the Wi-Fi network; and
a second connection unit, configured to cause the processor to connect the Wi-Fi router to the cloud server through the broadband network.

14. The system of claim 12, wherein the operator network is selected from a fourth generation of mobile phone mobile communication technology standards (4G) network, a third generation of mobile phone mobile communication technology standards (3G) network, and a second generation of mobile phone mobile communication technology standards (2G) network.
